(19) United States
(12) Patent Application Publication
(10) Pub. No.: US 2010/0145779 A1
(43) Pub. Date: Jun. 10, 2010

(54) System and Method for Performing Philanthropic Giving as Marketing Incentive

(75) Inventor: Robert E. Petcove, Voorhees, NJ (US)

Correspondence Address: FLASTER/GREENBERG P.C.;Four Penn Center, 1600 John F. Kennedy Boulevard, 2nd Floor, PHILADELPHIA, PA, 19103, US

(73) Assignee: Advanced Benefit Advisors, Inc., Cherry Hill, NJ (US)

(21) Appl. No.: 12/328,709

(22) Filed: Dec. 4, 2008

(51) Int. Cl. G06Q 40/00; G06Q 30/00; G06Q 50/00

(52) U.S. Cl. 705/14.11; 705/39

(57) ABSTRACT

A business organization attracts a client by way of philanthropic giving. The business organization arranges a partnership with a charitable cause where the charitable cause promotes the business organization to a client and the business organization pledges a donation of an amount of funds to the charitable cause based on doing business with the client. The business organization then establishes contact with the client by way of the charitable cause, communicates to the client a pledge from the business organization of a first amount of funds to the charitable cause if the client agrees to do business with the business organization, receives an agreement from the client to do business with the business organization, commences to do such business, and donates the first amount of funds to the charitable cause at a time relevant to a definition of the first amount of funds.

### BACKGROUND OF THE INVENTION

1. Field of the Invention

The present disclosure relates to a business organization or the like performing philanthropic giving, and in particular to such a business organization or the like that performs philanthropic giving as a marketing incentive to attract a client.

2. Description of Related Art

In any business organization, an age-old and recurring problem is how to attract a new client to partake of the goods and/or services offered by the business organization. As may be appreciated, much effort may be expended by or on behalf of the business organization to attract such a new client, and examples of such effort are many and numerous. For example, attracting the new client may be achieved by way of advertising, promotions, targeted contacts, introductions from mutual acquaintances, and the like.

Essentially, attracting a new client requires that the business organization somehow convince the new client that the organization can provide the goods and/or services that the client requires, and also that the new client should do business with the business organization rather than one or more other business organizations. Especially with regard to the latter point, it is to be understood that a new client oftentimes chooses to do business with a particular business organization for tangible and intangible reasons.

Such tangible reasons oftentimes are motivated by monetary considerations, such as whether the business organization can provide the goods and/or services at a reasonable cost and/or at a cost less than that of one or more other business organizations; by quality considerations, such as whether the business organization can provide the goods and/or services of a particular value or worth and with a minimum of flaws; by service considerations, such as whether the business organization can provide the goods and/or services at a specified time and with a minimum of errors; and the like.

However, such intangible reasons are by their nature harder to define, and oftentimes can only be described as idiosyncratic, unpredictable, and perhaps even peculiar. It is not unknown, for example, that a business organization receives business from a new client because a representative of the new client enjoyed playing golf with a representative of the business organization, or because the representative of the new client had a particularly good meal with a representative of the business organization. Perhaps more unusually, it may even be that the business organization receives business from the new client because the representative of the new client obtained a good stock market tip from a representative of the business organization, admired clothing a representative of the business organization was wearing, or received a compliment from the representative of the business organization.

For a business organization to attract a new client, then, the organization has to address both the tangible and intangible reasons that the new client may have for choosing to do business with the organization. Of particular interest here, the business organization has to provide the new client with intangible reasons for the new client to do business with the business organization that convince the new client that the business organization is a respectable, upright, and admirable organization. One way to so convince the new client is to show that the business organization is a significant contributor of philanthropic giving to worthy charitable causes

Accordingly, a need exists for a system and method employed by the business organization to perform philanthropic giving to a charitable cause that attracts the new client. In particular, a need exists for such a system and method where the philanthropic giving is performed by the business organization as an incentive to the new client to choose to do business with the business organization. Further, a need exists for such a system and method where the business organization receives assistance from the charitable cause in attracting the new client in return for the philanthropic giving to such charitable cause, and where the organization urges the new client to give to a charitable cause also.

### BRIEF SUMMARY OF THE INVENTION

The aforementioned needs are satisfied by a system and method performed by a business organization to attract a client by way of philanthropic giving. The business organization arranges a partnership with a charitable cause where the charitable cause agrees to promote the business organization to a client and the business organization agrees to pledge a donation of an amount of funds to the charitable cause based on doing business with the client. The business organization then establishes contact with the client by way of the charitable cause.

The business organization communicates to the client a pledge from the business organization of a first amount of funds to the charitable cause if the client agrees to do business with the business organization, receives an agreement from the client to do business with the business organization, and commences to do such business. The business organization then donates the first amount of funds to the charitable cause at a time relevant to a definition of the first amount of funds.

In one embodiment, a method performed by a business organization to attract a client by way of philanthropic giving is described herein, the method comprising the business organization: arranging a partnership with a charitable cause, wherein the charitable cause agrees to promote the business organization to a client and the business organization agrees to pledge a donation of an amount of funds to the charitable cause based on doing business with the client; establishing contact with the client by way of the charitable cause; communicating to the client a pledge from the business organization of a first amount of funds to the charitable cause if the client agrees to do business with the business organization; receiving an agreement from the client to do business with the business organization and commencing to do such business; and donating the first amount of funds to the charitable cause at a time relevant to a definition of the first amount of funds.

In preferred embodiments, the charitable cause may promote the business organization by identifying the business organization in promotional literature or the business organization may be promoted by targeting the client with information regarding the business organization.

The method may also include in preferred embodiments communicating to the client a request for a pledge of a donation from the client of a second amount of funds to the charitable cause or to another charity; and suggesting to the client that such client donate the second amount of funds to the charitable cause or to another charity at a time relevant to a definition of the second amount of funds, wherein the second amount of funds may be defined as a percentage of savings obtained by the client by doing business with the business organization rather than another business organization during a predefined period of time, and wherein the second amount of funds is donated to the charitable cause after the predefined period of time.

The method may also include in certain embodiments storing details of the requested pledge of the client in a database operating on a computing device when the request is made, and retrieving the stored details of the requested pledge from the database of the computing device when the client is suggested to donate the second amount of funds to the charitable cause or another charity, wherein the second amount of funds may be defined as a set amount of savings obtained by the client by doing business with the business organization rather than another business organization during a predefined period of time, and wherein the second amount of funds is donated to the charitable cause after the predefined period of time.

The method may also include storing details of the requested pledge of the client in a database operating on a computing device when the request is made, and retrieving the stored details of the requested pledge from the database of the computing device when the client is suggested to donate the second amount of funds to the charitable cause or to another entity.

The donation can be publicized to generate public awareness and goodwill for the business organization and the client.

Further, the first amount of funds may be defined as a percentage of revenue obtained by the business organization from the client during a predefined period of time, and wherein the first amount of funds is donated to the charitable cause after the predefined period of time. The first amount of funds may also be defined as a set amount if revenue obtained by the business organization from the client exceeds a threshold during a predefined period of time, and wherein the first amount of funds is donated to the charitable cause after the predefined period of time.

The method may also include storing details of the pledge of the business organization in a database operating on a computing device when the pledge is made, and retrieving the stored details of the pledge from the database of the computing device when the business organization is to donate the first amount of funds to the charitable cause.

In preferred embodiments, the business organization is a benefits advisor and broker and the client obtains benefits advice and brokerage services from the business organization.

The invention also includes a system operated on behalf of a business organization to attract clients by way of philanthropic giving, the system comprising, a database operating on a computing device, the database storing for each of a plurality of clients details of a pledge of the business organization with regard to the client when the pledge is made, and the stored details of the pledge being retrievable when the business organization is to donate a first amount of funds to a charitable cause, wherein when the business organization has arranged a partnership with the charitable cause in which the charitable cause has agreed to promote the business organization to the client and the business organization has agreed to donate an amount of funds to the charitable cause based on doing business with the client, the business organization has established contact with the client by way of the charitable cause and communicated to the client the stored pledge, such pledge being a first amount of funds to the charitable cause if the client agrees to do business with the business organization; and the business organization has received an agreement from the client to do business with the business organization and commences to do such business, the stored pledge is retrievable, and based on the retrieved pledge the first amount of funds are donated to the charitable cause at a time relevant to a definition of the first amount of funds.

The database in the system may further store for each of the plurality of clients details of a request for a pledge of a donation from the client of a second amount of funds to the charitable cause or to another charity when the request is made, and the stored details of the request are retrievable from the database when the business organization suggests to the client that such client donate the second amount of funds to the charitable cause or to another charity at a time relevant to a definition of the second amount of funds, wherein the second amount of funds may be defined as a percentage of savings obtained by the client by doing business with the business organization rather than another business organization during a predefined period of time, and wherein the second amount of funds is donated to the charitable cause after the predefined period of time. The second amount of funds may also be defined as a set amount of savings obtained by the client by doing business with the business organization rather than another business organization during a predefined period of time, and wherein the second amount of funds is donated to the charitable cause after the predefined period of time.

In the system, the first amount of funds may be defined as a percentage of revenue obtained by the business organization from the client during a predefined period of time, and wherein the first amount of funds is donated to the charitable cause after the predefined period of time. The first amount of funds may also be defined as a set amount if revenue obtained by the business organization from the client exceeds a threshold during a predefined period of time, and wherein the first amount of funds is donated to the charitable cause after the predefined period of time.

In preferred embodiments of the system, the business organization is a benefits advisor and broker and the client obtains benefits advice and brokerage services from the business organization.

A computing device is also described herein having a database operating on the computing device, wherein the database stores for each of a plurality of clients details of a pledge of the business organization with regard to the client when the pledge is made, and the stored details of the pledge are retrievable when the business organization is to donate a first amount of funds to a charitable cause, wherein when the business organization has arranged a partnership with the charitable cause in which the charitable cause has agreed to promote the business organization to the client and the business organization has agreed to donate an amount of funds to the charitable cause based on doing business with the client, the business organization has established contact with the client by way of the charitable cause and communicated to the client the stored pledge, such pledge being a first amount of funds to the charitable cause if the client agrees to do business with the business organization; and the business organization has received an agreement from the client to do business with the business organization and commences to do such business, the stored pledge is retrievable, and based on the retrieved pledge the first amount of funds are donated to the charitable cause at a time relevant to a definition of the first amount of funds.

### BRIEF DESCRIPTION OF THE SEVERAL VIEWS OF THE DRAWING(S)

The foregoing summary as well as the following detailed description of various embodiments of the present innovation will be better understood when read in conjunction with the appended drawings. For the purpose of illustrating the various embodiments of the innovation, there are shown in the drawings embodiments that are presently preferred. As should be understood, however, the innovation is not limited to the precise arrangements and instrumentalities shown. In the drawings:

FIG. 1 is a block diagram of a business organization attracting a client by way of philanthropic giving to a charitable cause in accordance with various embodiments of the present innovation; and

FIG. 2 is a flow diagram showing actions performed in connection with the business organization, client, and charitable cause of FIG. 1 in accordance with various embodiments of the present innovation.

### DETAILED DESCRIPTION OF THE INVENTION

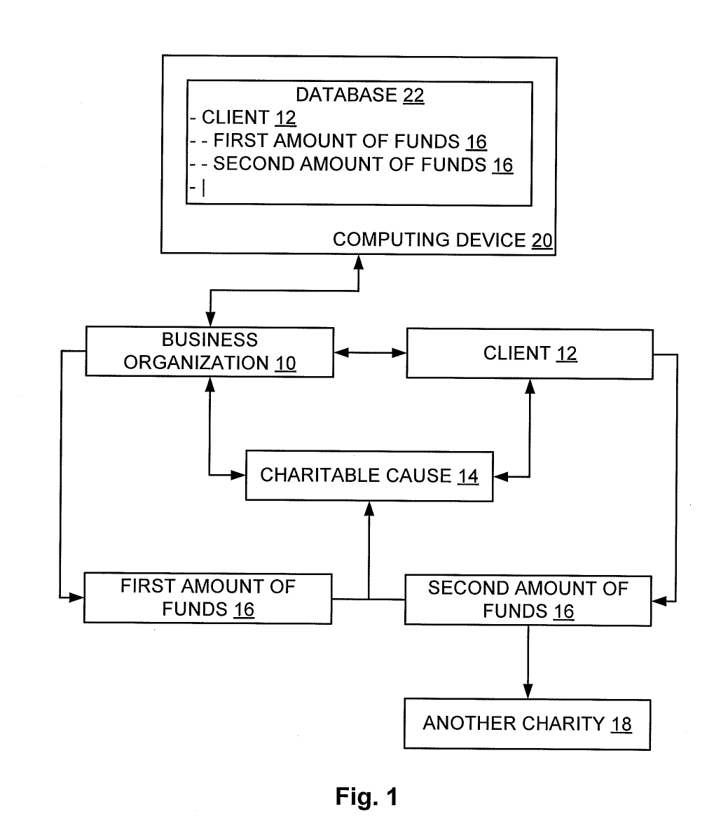

Turning now to FIG. 1, it is seen that a business organization 10 attracts a client 12 by way of a charitable cause 14 in accordance with various embodiments of the present innovation. As may be appreciated, each of the business organization 10, client 12, and charitable cause 14 may be any appropriate business organization, client, and charitable clause, respectively, without departing from the spirit and scope of the present innovation.

For example, the business organization 10 may be a company, various forms of corporations, a single person operating a business, a partnership operating a business, or the like, and may offer goods and/or services of interest to the client 12. In many but not necessarily all instances, the business organization 10 is an organization of the type that regularly attracts clients 12 by offering and providing goods and/or services thereto, and particularly clients 12 that intend to have a continuing relationship with the business organization 10 on an ongoing basis. The client 12 would presumably be an entity having an interest in availing itself of the goods and/or services provided by the business organization 10 or an entity that would be able to avail itself of the goods and/or services provided by the business organization 10 if those goods and/or services were presented to the client 12, and accordingly the client 12 may also be a company, a corporation, a single person operating a business, a single person acting as a consumer, a partnership operating a business, or the like.

Thus, particular instances of the business organization 10 and client 12 are numerous. Nevertheless examples of the business organization 10 and client 12 may include: an insurance company and a corporation regularly purchasing insurance policies from the insurance company on behalf of employees thereof; an insurance brokerage/advisor and a firm regularly employing the brokerage/advisor to obtain insurance services from one or more insurance companies; a software company and an office products retailer regularly purchasing copies of a retail version of a software product from the software company; a software developer and a software purchaser that regularly commissions the software developer to develop specialized software therefor; a heavy machinery manufacturer and a construction firm that regularly purchases factory machines from the manufacturer; an automobile leasing agency and a fleet manager of a police department that regularly leases vehicles from the agency; a law firm and potential law firm clients, and the like.

As was set forth above, the client 12 may have both tangible and intangible reasons for choosing whether to do business with the business organization 10. Again, the tangible reasons include monetary, quality, and service considerations and the like, while the intangible reasons are more arbitrary and even idiosyncratic, perhaps. Particularly with regard to the intangible reasons, then, although perhaps relevant to the tangible reasons too, the business organization 10 may want to convince the client 12 that the business organization 10 is a respectable, upright, and admirable organization, especially when attempting to attract the client 12 initially.

In various embodiments of the present innovation, then, the manner in which the business organization 10 may convince the client 12 that the business organization 10 is a respectable, upright, and admirable organization is by showing that the business organization 10 is a significant contributor of philanthropic giving to worthy charitable causes, including the charitable cause 14. Of course, the business organization 10 may also be a significant contributor of philanthropic giving to worthy charitable causes for other reasons aside from attracting the client 12, and in fact may have a long-standing tradition of such philanthropic giving as a responsible member of society, among other things.

Note here that the charitable cause 14 may be any non-profit organization or charitable cause without departing from the spirit and scope of the present innovation. For example, the charitable cause 14 may be a well-known charity such as the American Red Cross, the Magic Johnson Foundation, or the American Cancer Society; an educational institution such as Cornell University, the Temple University School of Law, or the University of Hartford; a health care facility such as the Mayo Clinic, the Hospital of the University of Pennsylvania, or the Boca Raton Community Hospital; Habitat for Humanity; Big Brothers/Big Sisters; PAL and the like. Likewise, the charitable cause 14 may be a less-well-known charity, a personal foundation, a charitable trust, or another charitable organization.

One way among many for the business organization 10 to emphasize to the client 12 that the business organization 10 is a significant contributor of philanthropic giving to worthy charitable causes is to pledge to the client 12 that the business organization 10 will donate a defined first amount of funds 16 to the charitable cause 14 if the client 12 agrees to do business with the business organization 10. Presumably, although by no means necessarily, the pledge to donate the first amount of funds 16 is performed as part of the process of attracting the client 12 to do business with the business organization 10, and therefore may be incorporated into a sales pitch to the client 12, a presentation to the client 12, a request for proposal or even an initial conversation with the client 12, for example.

The first amount of funds 16 pledged may be defined in any appropriate manner without departing from the spirit and scope of the present innovation. For example, the defined first amount of funds 16 may be a percentage of the revenue obtained by the business organization 10 from the client 12 during a predefined period of time, such as for example the first year that the client 12 does business with the business organization 10. Likewise, the defined first amount of funds 16 may be a set amount if the revenue obtained by the business organization 10 from the client 12 during a predefined period of time exceeds a threshold value, or even a laddered group of set amounts as the revenue obtained by the business organization 10 from the client 12 during a predefined period of time exceeds a series of increasing thresholds, among other things. Further, it is within the scope of the invention that the first amount of funds 16 pledged may be pledged not only as monetary funds but in the form of volunteer services having an equivalent commercial monetary value to a pledged amount of funds. For example, instead of pledging $10,000 in cash, the business organization may pledge $10,000 worth of volunteer services (pro bono work or charity volunteer work) to a charitable cause.

Notably, such a first amount of funds 16 can be considerable, especially if the nature of the business of the business organization 10 as availed by the client 12 so affords. For example, it may be the case that the business organization 10 is a benefits advisor and/or broker and the client 12 obtains benefits advice and brokerage services from the business organization 10, in which case the revenue in a single year can amount to hundreds of thousands of dollars if not millions of dollars, especially if the client 12 is relatively large. In such a case, and where the first amount of funds 16 is defined as 10 percent of such revenue, the pledged donation by the business organization 10 to the charitable cause 14 can easily reach tens of thousands of dollars if not hundreds of thousands of dollars.

Significantly, the pledge from the business organization 10 to the client 12 may be accompanied by a request that the client 12 also donate a second amount of funds 16 to the charitable cause 14, or to another charity 18. As before, the requested donation of the second amount of funds 16 may be defined in any appropriate manner without departing from the spirit and scope of the present innovation. For example, the defined second amount of funds 16 may be a percentage of the savings obtained by the client 12 by doing business with the business organization 10 rather than another business organization during a predefined period of time, such as for example the first year that the client 12 does business with the business organization 10. Likewise, the defined second amount of funds 16 may be a set amount or laddered group of set amounts based on one or more thresholds of such savings. The defined second amount of funds 16 may also be in the form of pledged services as noted above with respect to the first amount of funds.

Such a second amount of funds 16 can also be considerable, again if the nature of the business of the business organization 10 as availed by the client 12 so affords. For example, in the above case where the business organization 10 is a benefits advisor and/or broker and the client 12 obtains benefits advice and brokerage services from the business organization 10, it may be that the client 12 saves hundreds of thousands of dollars if not millions of dollars based on the benefits advice and brokerage services provided, especially if the client 12 is relatively large. In such a case, and where the second amount of funds 16 is defined as 10 percent of such savings, the requested donation by the client 12 to the charitable cause 14 can easily reach tens of thousands of dollars if not hundreds of thousands of dollars.

As may be appreciated, the requested pledge of the second amount of funds from the client 12 to the charitable cause 14 or another charity 18 emphasizes that the business organization 10 is not pledging the first amount of funds 16 merely as a marketing device, but because the business organization 10 cares about the charitable cause 14 and would appreciate that others including the client 12 care about the charitable cause 14 too. As such, the stature of the business organization 10 as perceived by the client 14 is increased. Additionally, if the second amount of funds 16 to be donated by the client 12 is defined according to the savings obtained by the client 12 by doing business with the business organization 10 rather than another business organization, the implication is that the client 12 will receive such savings by agreeing to do business with the business organization 10, and such an implication thus acts as an impetus for the client 12 to in fact do business with the business organization 10.

Note here that the client 12 should be free to decide whether to in fact pledge the second amount of funds 16 to the charitable cause 14 or to another charity 18. Accordingly, such second amount of funds 16 is a donation from the client 12 and not a rebate or other return of value from the business organization 10 to the client 12. If the client 12 is in fact free to decide whether to pledge the second amount of funds 16, the client 12 is not under any legal obligation to do so, although a moral obligation may nevertheless arise. Thus, the client 12 may choose to in fact donate the second amount of funds 16 to the charitable cause 14, donate the second amount of funds 16 to the another charity 18, donate some amount of funds 16 to the charitable cause 14, donate some amount of funds 16 to the another charity 18, or even donate nothing.

In various embodiments of the present innovation, the charitable cause 14 to which the business organization 10 pledges to donate the first amount of funds 16 is a partner charitable cause 14. In particular, such partner charitable cause 14 has previously agreed to actively promote the business organization 10 and refer the client 12 to the business organization 10 in return for the pledge of the first amount of funds 16 from the business organization 10 and the potential for the second amount of funds 16 from the client 12. Thus, the business organization 10 and the partner charitable cause 14 are effectively a team, where each member of the team benefits from the agreement.

That is, the business organization 10 benefits by receiving the business of the client 12. Also, the charitable cause 14 benefits by receiving the first amount of funds from the business organization 10 upon the client 12 giving business to the business organization 10, and hopefully the second amount of funds from the client 12 upon the client achieving savings from agreeing to do business with the business organization 10. Notably, the charitable cause 14 receiving the second amount of funds 16 from the client 14 is especially advantageous inasmuch as the charitable cause 14 need not solicit such client 14 directly for such second amount of funds 16. As should be understood, such a solicitation is oftentimes a difficult proposition and is met from resistance by the client 12, typically for economic reasons. Instead, the charitable cause 14 can suggest that the client 12 avail itself of the goods and/or services of the business organization 10, as per the arrangement between such charitable cause 14 and such business organization 10. Upon the client 12 in fact achieving savings by doing business with the business organization 10, then, the client 12 will (hopefully) provide the second amount of funds 16 to the charitable cause 14 in due course, without having been solicited directly.

In addition, the client 12 benefits by doing business with the business organization 10, especially if the client achieves the aforementioned savings. Moreover, the client 12 may also benefit from other factors. For one thing, the pledge of the second amount of funds 16 from the client 12 to the charitable cause 14 is likely a charitable contribution for tax purposes and therefore acts to reduce taxes owed. For another, the pledge of the second amount of funds 16 from the client 12 to the charitable cause 14 likely will generate an amount of goodwill that inures to the client 12, from employees or other members of the client 12 and also third parties who are made aware of such pledge.

In various embodiments of the present innovation, then, the business organization 10 and/or the charitable cause 14 may employ appropriate publicity to generate such awareness. Such publicity may take any appropriate form, including but not limited to notices in newspapers, magazines, web sites, and other public forums, donation ceremonies, donation commemoratives or mementos, and the like.

Note here that if the client 12 chooses to donate the second amount of funds 16 to the another charity 18, as was set forth above, the business organization 10 can take such a donation as an opportunity to establish a relationship with the another charity 18 similar to the relationship the business organization 10 already has with the charitable cause 14. Thus, the another charity 18 may also be persuaded to agree to actively promote the business organization 10 in a manner akin to the charitable cause 14. In doing so, it may be appreciated that the business organization 10 can develop a network of charitable causes 14, each of which has agreed to actively promote the business organization 10.

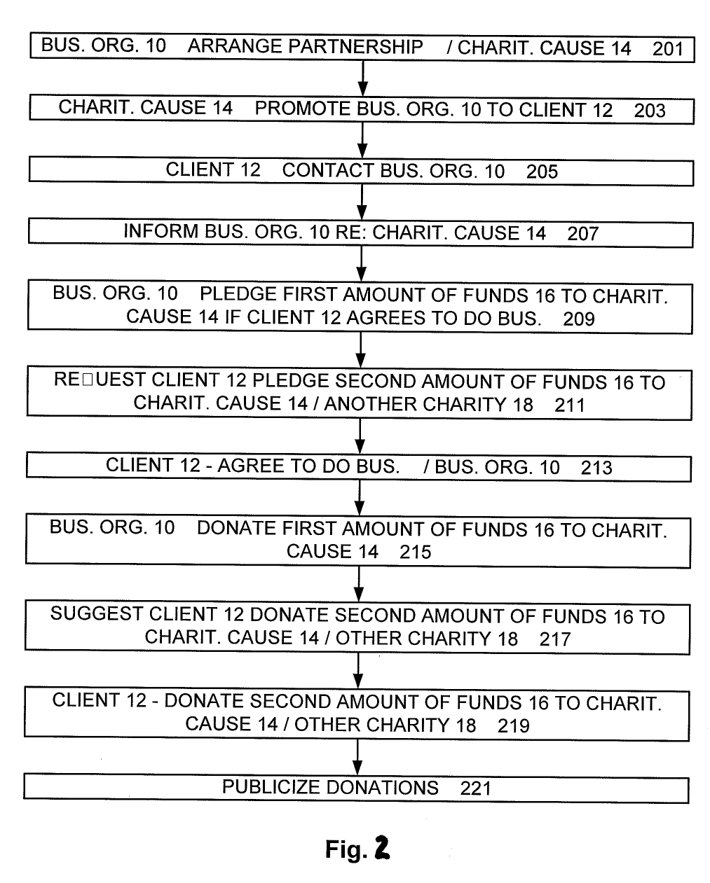

Turning now to FIG. 2, it is seen that a method employed in connection with the business organization 10, the client 12, and the charitable cause 14 of FIG. 1 is shown. Preliminarily, and as should now be appreciated, the business organization 10 arranges a partnership with the charitable cause 14, either at the behest of the business organization 10 or the charitable cause 14 (201). In the partnership, and as was set forth above, the charitable cause 14 agrees to actively promote the business organization 10 and refer clients including the client 12 to the business organization 10, in return for which the business organization agrees to pledge the first amount of funds 16 based on doing business with the client 12.

Note here that the active promotion by the charitable cause 14 on behalf of the business organization 10 may take any appropriate form. For example, the charitable cause 14 may identify the business organization 10 in various promotional literature, and in doing so may detail the partnership and how the charitable cause 14 can benefit if a client such as the client 12 chooses to do business with the business organization 10. The charitable cause 14 may even actively target the client 12 with relevant information regarding doing business with the business organization 10, whereby the charitable cause 14 does not solicit a donation directly but instead asks for the second amount of funds 16 as was set forth above.

At any rate, the charitable cause 14 does in fact actively promote the business organization 10 to clients including the client 12 (203), with the result being that the client 12 develops an interest in the goods and/or services of the business organization 10 and contact is established therebetween (205). Such contact may be initiated by either the client 12 or the business organization 10, but in either case the client 12 informs the business organization 10 that the interest is based at least in part on the active promotion of the charitable cause 14 (207). Based thereon, the business organization 10 makes the aforementioned pledge of the first amount of funds 16 if the client 12 agrees to do business with the business organization 10 (209), and requests that the client 12 also pledge to donate the second amount of funds 16 to the charitable cause 14, or to another charity 18 (211).

Presuming that the client 12 does in fact agree to do business with the business organization 10 (213), such business in fact commences. Thereafter, and at some appropriate point relevant to how the first amount of funds 16 is defined, the business organization 10 in fact donates the first amount of funds 16 to the charitable cause 14 (215). Likewise, at some appropriate point relevant to how the second amount of funds 16 is defined, the business organization 10 suggests to the client 12 that such client 12 in fact donate the second amount of funds 16 to the charitable cause 14 or to another charity 18 (217), and presumably the client 12 in fact so donates (219). In connection with the donations, then, and as was set forth above, the business organization 10 and/or the charitable cause 14 appropriately publicize the donations to generate public awareness and goodwill, both for the business organization 10 and the client 12 (221).

Referring again to FIG. 1, it is seen that the business organization 10 may employ a computing device 20 with an appropriate database 22 to record the pledges of such business organization 10 and client 12, particularly if the business organization 10 makes such pledges with regard to multiple clients 12. The computing device 20 and database 22 may be any appropriate computing device and database without departing from the spirit and scope of the present innovation, presuming of course that the computing device 20 is sufficiently programmed and the database 22 is sufficiently structured to perform the functions set forth herein including storing details regarding the client(s) 12 such that the stored details in the database are retrievable for timely executing payment or satisfaction of the pledge of the first amount of funds and/or second amount of funds. As may be appreciated, such functions and structures should be apparent to the relevant public based on the present disclosure and therefore need not be set forth herein in any detail beyond that which is provided.

As should be understood, then, details of the pledges of the business organization 10 and each client 12 may be recorded in the database 22 of the computing device 20 when made/requested at 209 and 211. Likewise, the details of the pledges may be recalled from the database 22 of the computing device 20 at the appropriate point when the business organization 10 is to donate the first amount of funds 16 to the charitable cause 14 as at 215, and at the appropriate point when the business organization 10 is to suggest to the client 12 that such client donate the second amount of funds 16 to the charitable cause 14 or to another charity 18 as at 217.

The programming believed necessary to effectuate the processes performed in connection with the various embodiments of the present innovation is relatively straight-forward and should be apparent to the relevant programming public. Accordingly, such programming is not attached hereto. Any particular programming, then, may be employed to effectuate the various embodiments of the present innovation without departing from the spirit and scope thereof.

In the present innovation, a method and mechanism are provided by which a business organization 10 performs philanthropic giving to a charitable cause 14 that attracts a client 12. The philanthropic giving is performed by the business organization 10 as an incentive to the client 12 to choose to do business with the business organization 10. The business organization 10 receives assistance from the charitable cause 14 in attracting the client 12 in return for the philanthropic giving to such charitable cause 14.

It should be appreciated that changes could be made to the embodiments described above without departing from the innovative concepts thereof. For example, although the present innovation is set forth primarily in terms of the business organization 10 attracting clients 12 by way of a partner charitable cause 14, such innovation may also be practiced by a charitable cause 14 attracting clients 12 with regard to multiple partner business organizations 10. It should be understood, therefore, that this innovation is not limited to the particular embodiments disclosed, but it is intended to cover modifications within the spirit and scope of the present innovation as defined by the appended claims.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A method performed by a business organization to attract a client by way of philanthropic giving, the method comprising the business organization:
arranging a partnership with a charitable cause, wherein the charitable cause agrees to promote the business organization to a client and the business organization agrees to pledge a donation of an amount of funds to the charitable cause based on doing business with the client;
establishing contact with the client by way of the charitable cause;
communicating to the client a pledge from the business organization of a first amount of funds to the charitable cause if the client agrees to do business with the business organization;
receiving an agreement from the client to do business with the business organization and commencing to do such business; and
donating the first amount of funds to the charitable cause at a time relevant to a definition of the first amount of funds.

2. The method of claim 1, wherein the charitable cause promotes the business organization by identifying the business organization in promotional literature.

3. The method of claim 1, wherein the charitable cause promotes the business organization by targeting the client with information regarding the business organization.

4. The method of claim 1, further comprising:
communicating to the client a request for a pledge of a donation from the client of a second amount of funds to the charitable cause or to another charity; and
suggesting to the client that such client donate the second amount of funds to the charitable cause or to another charity at a time relevant to a definition of the second amount of funds.

5. The method of claim 4, wherein the second amount of funds is defined as a percentage of savings obtained by the client by doing business with the business organization rather than another business organization during a predefined period of time, and wherein the second amount of funds is donated to the charitable cause after the predefined period of time.

6. The method of claim 5, further comprising storing details of the requested pledge of the client in a database operating on a computing device when the request is made, and retrieving the stored details of the requested pledge from the database of the computing device when the client is suggested to donate the second amount of funds to the charitable cause or another charity.

7. The method of claim 4, wherein the second amount of funds is defined as a set amount of savings obtained by the client by doing business with the business organization rather than another business organization during a predefined period of time, and wherein the second amount of funds is donated to the charitable cause after the predefined period of time.

8. The method of claim 7, further comprising storing details of the requested pledge of the client in a database operating on a computing device when the request is made, and retrieving the stored details of the requested pledge from the database of the computing device when the client is suggested to donate the second amount of funds to the charitable cause or to another entity.

9. The method of claim 1, wherein the donation is publicized to generate public awareness and goodwill for the business organization and the client.

10. The method of claim 1, wherein the first amount of funds is defined as a percentage of revenue obtained by the business organization from the client during a predefined period of time, and wherein the first amount of funds is donated to the charitable cause after the predefined period of time.

11. The method of claim 1, wherein the first amount of funds is defined as a set amount if revenue obtained by the business organization from the client exceeds a threshold during a predefined period of time, and wherein the first amount of funds is donated to the charitable cause after the predefined period of time.

12. The method of claim 1, further comprising storing details of the pledge of the business organization in a database operating on a computing device when the pledge is made, and retrieving the stored details of the pledge from the database of the computing device when the business organization is to donate the first amount of funds to the charitable cause.

13. The method of claim 1, wherein the business organization is a benefits advisor and broker and the client obtains benefits advice and brokerage services from the business organization.

14. A system operated on behalf of a business organization to attract clients by way of philanthropic giving, the system comprising,
a database operating on a computing device, the database storing for each of a plurality of clients details of a pledge of the business organization with regard to the client when the pledge is made, and the stored details of the pledge being retrievable when the business organization is to donate a first amount of funds to a charitable cause,
wherein when the business organization has arranged a partnership with the charitable cause in which the charitable cause has agreed to promote the business organization to the client and the business organization has agreed to donate an amount of funds to the charitable cause based on doing business with the client,
the business organization has established contact with the client by way of the charitable cause and communicated to the client the stored pledge, such pledge being a first amount of funds to the charitable cause if the client agrees to do business with the business organization;
and the business organization has received an agreement from the client to do business with the business organization and commences to do such business, the stored pledge is retrievable, and based on the retrieved pledge the first amount of funds are donated to the charitable cause at a time relevant to a definition of the first amount of funds.

15. The system of claim 14, wherein the database further stores for each of the plurality of clients details of a request for a pledge of a donation from the client of a second amount of funds to the charitable cause or to another charity when the request is made, and the stored details of the request are retrievable from the database when the business organization suggests to the client that such client donate the second amount of funds to the charitable cause or to another charity at a time relevant to a definition of the second amount of funds.

16. The system of claim 15, wherein the second amount of funds is defined as a percentage of savings obtained by the client by doing business with the business organization rather than another business organization during a predefined period of time, and wherein the second amount of funds is donated to the charitable cause after the predefined period of time.

17. The system of claim 15, wherein the second amount of funds is defined as a set amount of savings obtained by the client by doing business with the business organization rather than another business organization during a predefined period of time, and wherein the second amount of funds is donated to the charitable cause after the predefined period of time.

18. The system of claim 14, wherein the first amount of funds is defined as a percentage of revenue obtained by the business organization from the client during a predefined period of time, and wherein the first amount of funds is donated to the charitable cause after the predefined period of time.

19. The system of claim 14, wherein the first amount of funds is defined as a set amount if revenue obtained by the business organization from the client exceeds a threshold during a predefined period of time, and wherein the first amount of funds is donated to the charitable cause after the predefined period of time.

20. The system of claim 14, wherein the business organization is a benefits advisor and broker and the client obtains benefits advice and brokerage services from the business organization.

21. A computing device having a database operating on the computing device, wherein the database stores for each of a plurality of clients details of a pledge of the business organization with regard to the client when the pledge is made, and the stored details of the pledge are retrievable when the business organization is to donate a first amount of funds to a charitable cause,
wherein when the business organization has arranged a partnership with the charitable cause in which the charitable cause has agreed to promote the business organization to the client and the business organization has agreed to donate an amount of funds to the charitable cause based on doing business with the client,
the business organization has established contact with the client by way of the charitable cause and communicated to the client the stored pledge, such pledge being a first amount of funds to the charitable cause if the client agrees to do business with the business organization;
and the business organization has received an agreement from the client to do business with the business organization and commences to do such business, the stored pledge is retrievable, and based on the retrieved pledge the first amount of funds are donated to the charitable cause at a time relevant to a definition of the first amount of funds.
